(19) United States
(12) Patent Application Publication
(10) Pub. No.: US 2017/0004406 A1
(43) Pub. Date: Jan. 5, 2017

(54) PARALLEL BELIEF SPACE MOTION PLANNER

(71) Applicant: QUALCOMM Incorporated, San Diego, CA (US)

(72) Inventor: Aliakbar AGHAMOHAMMADI, San Diego, CA (US)

(21) Appl. No.: 14/941,465

(22) Filed: Nov. 13, 2015

Related U.S. Application Data
(60) Provisional application No. 62/187,223, filed on Jun. 30, 2015.

(51) Int. Cl. G06N 5/04; G06N 99/00; G06N 7/00

(52) U.S. Cl. CPC G06N 5/045; G06N 7/005; G06N 99/005

(57) ABSTRACT

A method for generating a movement policy includes determining a probability distribution function for multiples nodes of a roadmap and determining, in parallel, a cost and a collision probability for each edge of the roadmap. The method also includes generating the movement policy based on the probability distribution function, the cost, and the collision probability.

### CROSS-REFERENCE TO RELATED APPLICATION

The present application claims the benefit of U.S. Provisional Patent Application No. 62/187,223, filed on Jun. 30, 2015, and titled “PARALLEL BELIEF SPACE MOTION PLANNER,” the disclosure of which is expressly incorporated by reference herein in its entirety.

### BACKGROUND

Field

Certain aspects of the present disclosure generally relate to machine learning and, more particularly, to improving systems and methods of determining a movement policy based on parallel planning.

Background

It is desirable for autonomous systems, such as robots, to have the ability to make decisions in view of uncertainty. That is, in the presence of uncertainty in a robot's motion and uncertainty in the robot's sensory readings, the true robot state is not available for decision-making purposes. In such cases, a state estimation module may provide a probability distribution over all possible states. The probability distribution over all possible states may be referred to as an information state or a belief. Thus, decision-making in view of motion uncertainties and sensing uncertainties should be performed in an information space (e.g., belief space). In some cases, the decision-making can be formulated as specific type of problem, such as a partially observable Markov decision process (POMDP) problem. However, in most cases, a small class of problems formulated using POMDP can be solved because of POMDP's computational complexity.

Alternatively, in the absence of uncertainty, sampling-based path-planning solutions including graph-based methods, such as probabilistic roadmap methods, and tree-based methods, such as rapidly-exploring randomized trees (RRTs) and expansive space trees, have improved robot motion planning. Nevertheless, direct transformation of the roadmap-based methods to planning under uncertainty in a belief space is challenging. Specifically, in some cases, it may be difficult to ensure that roadmap nodes are reachable. Furthermore, the incurred costs on different edges of the roadmap depend on each other.

Thus, it is desirable to provide a solution to ensure that roadmap nodes are reachable. Furthermore, it is desirable to independently determine the incurred costs of different edges of the roadmap.

### SUMMARY

In one aspect of the present disclosure, a method for generating a movement policy is disclosed. The method includes determining a probability distribution function for a plurality of nodes of a roadmap. The multiple nodes include a start node, an end node, and at least two intermediary nodes. The method also includes determining, in parallel, a cost and a collision probability for each edge of the roadmap. Each edge connects two of the multiple nodes. The method further includes generating the movement policy based on the probability distribution function, the cost, and the collision probability.

Another aspect of the present disclosure is directed to an apparatus including means for determining a probability distribution function for multiple nodes of a roadmap. The multiple nodes include a start node, an end node, and at least two intermediary nodes. The apparatus also includes means for determining, in parallel, a cost and a collision probability for each edge of the roadmap. Each edge connects two of the multiple nodes. The apparatus further includes means for generating the movement policy based on the probability distribution function, the cost, and the collision probability.

In another aspect of the present disclosure, a non-transitory computer-readable medium with non-transitory program code recorded thereon is disclosed. The program code for generating a movement policy is executed by a processor and includes program code to determine a probability distribution function for multiple nodes of a roadmap. The multiple nodes include a start node, an end node, and at least two intermediary nodes. The program code also includes program code to determine, in parallel, a cost and a collision probability for each edge of the roadmap. Each edge connects two of the multiple nodes. The program code further includes program code to generate the movement policy based on the probability distribution function, the cost, and the collision probability.

Another aspect of the present disclosure is directed to an apparatus for generating a movement policy, the apparatus having a memory unit and at least one processor coupled to the memory unit. The processor(s) is configured to determine a probability distribution function for multiple nodes of a roadmap. The multiple nodes include a start node, an end node, and at least two intermediary nodes. The processor(s) is also configured to determine, in parallel, a cost and a collision probability for each edge of the roadmap. Each edge connects two of the multiple nodes. The processor(s) is further configured to generate the movement policy based on the probability distribution function, the cost, and the collision probability.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of motion planning with a system-on-a-chip (SOC), including a general-purpose processor in accordance with certain aspects of the present disclosure.

FIG. 2 illustrates an example implementation of a system in accordance with certain aspects of the present disclosure.

FIG. 3 illustrates an example of a movement policy.

FIG. 4 illustrates an example of various paths and their associated uncertainty.

FIG. 5 illustrates an example of a flow diagram for motion planning based on the partially-observable Markov decision process (POMDP).

FIG. 6 illustrates an example of a conventional state space and belief space.

FIG. 7 illustrates an example of a state space and a belief space according to aspects of the present disclosure.

FIGS. 8-9 illustrate flow diagrams for methods for motion planning according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

For autonomous systems, such as robots, it is desirable to generate a policy for actions, such as movement of the robot, based on an autonomous system's information. The policy may be referred to as a movement policy. The policy is used to determine subsequent actions for an autonomous system. That is, when an autonomous system is in a first state, the policy determines an action that leads to a second state for the autonomous system.

Typically, a policy with a low cost and a low collision probability is desirable. Thus, a policy is selected after determining a cost and a collision probability for each node/edge along a path. In conventional systems, the costs and collision probabilities are serially calculated because each node/edge is dependent on previous nodes/edges. Aspects of the present disclosure are directed to independently determining the costs and collision probabilities for each edge, such that the costs and collision probabilities may be determined in parallel. For example, a first cost and a first collision probability of a first edge of multiple edges is independent of a second cost and a second collision probability of a second edge of the multiple edges. In some cases, the collision probability may be referred to as a transition probability.

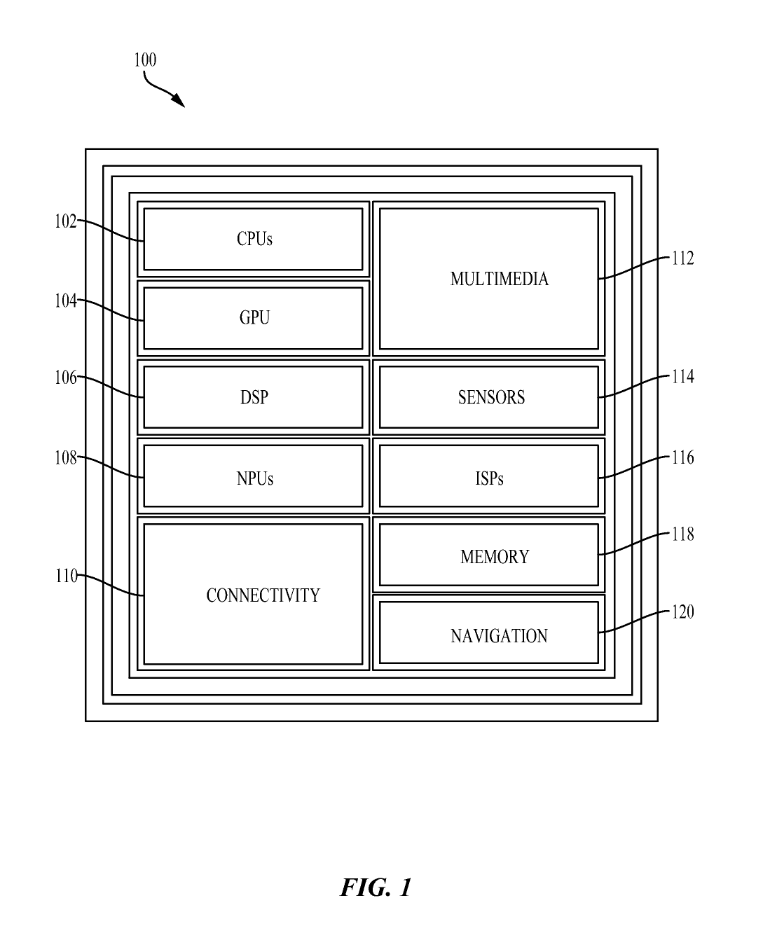

FIG. 1 illustrates an example implementation 100 of the aforementioned parallel belief space motion planner using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation 120, which may include a global positioning system.

The SOC may be based on an ARM instruction set. In an aspect of the present disclosure, the instructions loaded into the general-purpose processor 102 may comprise code for determining a probability distribution function for nodes of a roadmap. The instructions loaded into the general-purpose processor 102 may also comprise code for determining, in parallel, a cost and a collision probability for each edge of the roadmap, and each edge connecting two of the nodes. The instructions loaded into the general-purpose processor 102 may further comprise code for generating the movement policy based on the probability distribution function and the cost and collision probability.

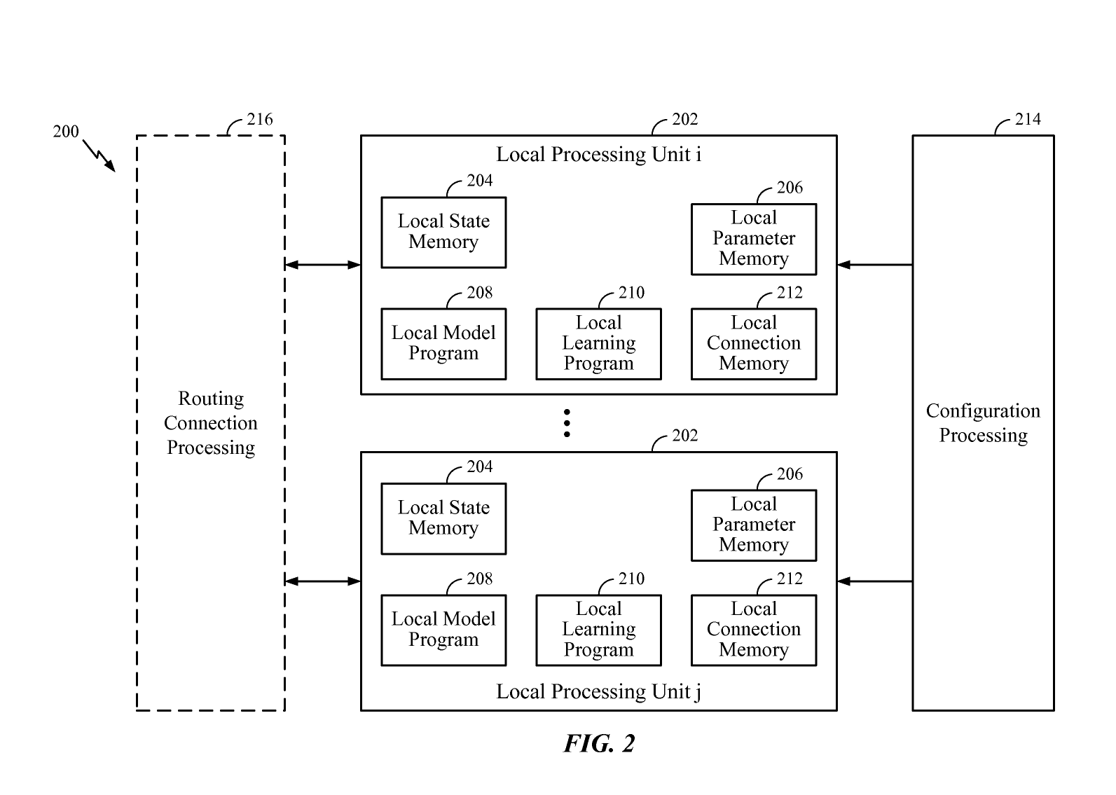

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

In one configuration, a movement policy model is configured for determining a probability distribution function (PDF) for nodes of a roadmap, determining, in parallel, a cost and a collision probability for each edge of the roadmap, each edge connecting two of the nodes, and generating the movement policy based on the PDF and the cost and collision probability. The model includes a determining means and/or generating means. In one aspect, the determining means and/or generating means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

According to certain aspects of the present disclosure, each local processing unit 202 may be configured to determine parameters of the model based upon desired one or more functional features of the model, and develop the one or more functional features towards the desired functional features as the determined parameters are further adapted, tuned and updated.

### Parallel Belief Space Motion Planner

For autonomous systems, such as robots, it is desirable to generate a policy for actions, such as movement of the robot, based on an autonomous system's information. The policy determines movement to an end node from any other of the nodes. That is, the policy may determine subsequent actions for an autonomous system. Thus, when an autonomous system is in a first state, the policy determines the next action that leads to a second state for the autonomous system.

Aspects of the present disclosure will use a robot as an example of an autonomous system. Still, aspects of the present disclosure are not limited to a robot and are also applicable for other types of autonomous systems, such as driverless cars and/or drones, for example.

Different policies may have different objectives. In one example, the objective of a policy is to have a robot move from point A to point B. In some cases, the robot may not follow instructions as planned due to noise and/or uncertainty. Therefore, to improve the robot's ability to reach the desired goal, the policy should account for the noise and/or uncertainty. For example, the policy may account for motion noise, sensor noise, obstacles, control thresholds, and/or uncertainty.

Motion noise refers to noise in the system's motion, such as wind affecting the motion of a robot. Sensor noise refers to noise in the measurement of a sensor, such as a camera or laser-range finder. For example, if the robot is one meter from a wall, the sensor may measure one and a half meters due to sensor noise. Additionally, obstacles may be in the path of the robot, such as buildings, rocks, trees, and/or rivers. Control thresholds refer to thresholds of the robot, such as thresholds for the robot's velocity.

As previously discussed, uncertainty refers to a robot's motion uncertainty and/or the robot's sensory uncertainty such that the robot's actual location may not be available for decision-making purposes. That is, uncertainty may refer to the lack of certain information to determine the robot's actual position. Accordingly, the uncertainty increases as less information, such as sensor information and/or motion information, is available.

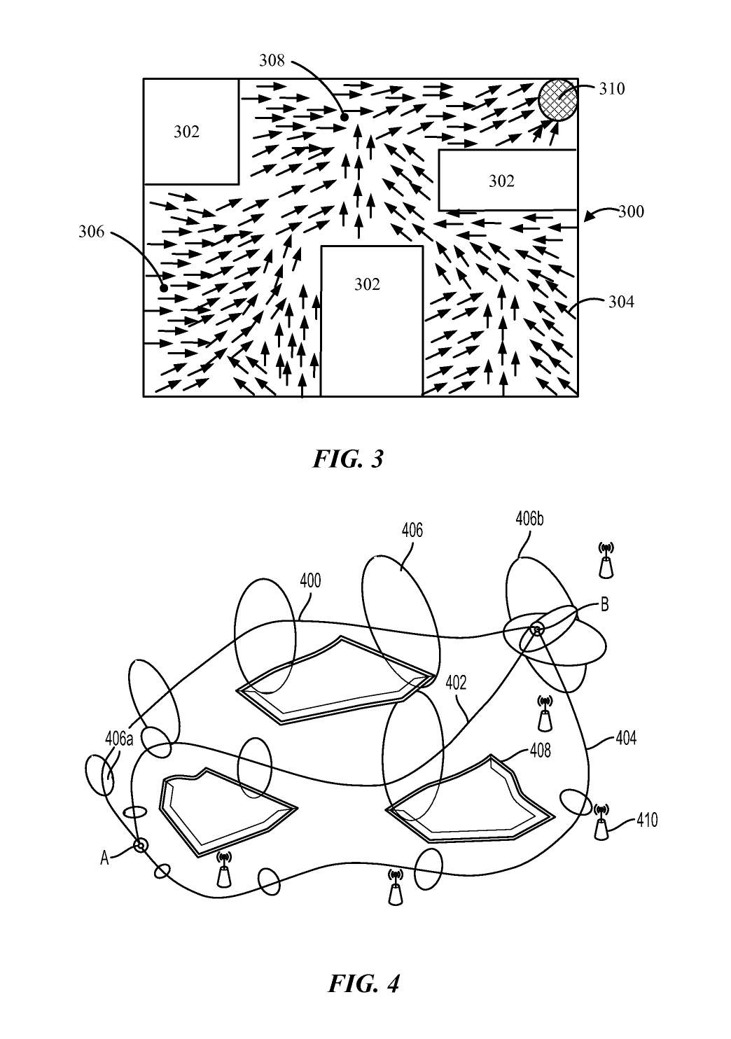

FIG. 3 illustrates a top-down view of an example of a policy for movement of a robot in an area 300. As shown in FIG. 3, the area 300 has various obstacles 302. Furthermore, for the area 300, the robot is given a policy so that the robot has a specified path when a robot is in a given location in the area 300. For FIG. 3, the policy is shown via the arrows 304. Based on a policy for a robot (not shown) of FIG. 3, when the robot is in a specific location in the area 300, the robot moves in the direction indicated by an arrow 304 that corresponds to the location of the robot. Based on the example of FIG. 3, the policy will guide the robot to the top right corner of the environment (e.g., the goal 310).

That is, based on the flow of the arrows 304, if the robot is placed in a first location 306 of the area 300, the robot will eventually reach the goal 310 via a first path. Additionally, if the robot is placed in a second location 308, the robot will eventually reach the goal 310 via a second path that is different from the first path. The paths may differ because the robot may face different noise and/or uncertainty based on the location of the robot.

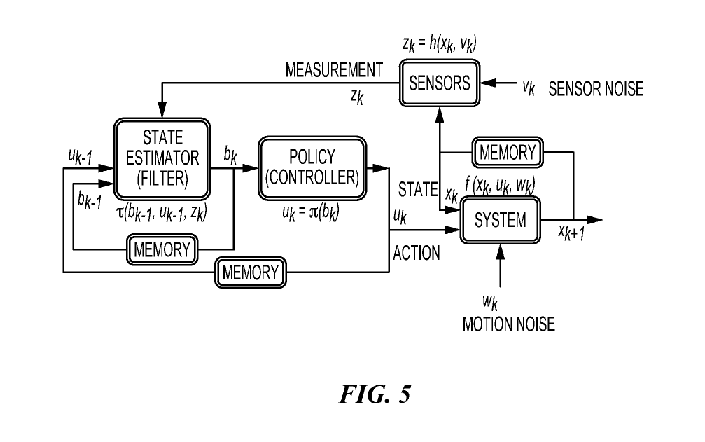

FIG. 4 illustrates an example of various paths 400-404 that a robot may take to move from point A to point B. FIG. 4 also illustrates different levels of uncertainty 406 associated with different sections of each path 400-404. In the example shown in FIG. 4, the amount of uncertainty in a robot's location is in proportion to a size of the ellipse, such that the amount of uncertainty in the robot's location increases as the size of the ellipse increases.

The contour of the uncertainty 406 may be based on a Gaussian distribution. More specifically, the uncertainty 406 represents an area that the robot may be located. In most cases, there is an increased probability that the robot is in the center of the uncertainty 406. However, the exact location of the robot is not known. That is, that the robot may be within any location of the uncertainty 406. As a result of the uncertainty, the robot may collide with obstacles 408 or have an increased cost for travelling from point A to point B.

As shown in FIG. 4, the uncertainty 406 may change along a path. For example, for the first path 400, the uncertainty 406a is smaller at the beginning of the path in comparison to the uncertainty 406b at the end of the path. Additionally, as shown in FIG. 4, the sizes of the uncertainty 406 for the first path are larger in comparison to the sizes of the uncertainty 406 for the second path 402 and for the third path 404. That is, if the robot were to move along the first path 400, there would be less information available for the robot in comparison to the information available if the robot moved along the second path 402 or the third path 404. Accordingly, to lower at least a movement cost and/or a collision probability, it is desirable to select a policy that enables the robot to select a path with uncertainty that is less than the uncertainty of other paths.

Furthermore, as shown in FIG. 4, the third path 404 has less uncertainty 406 in comparison to the second path 402. That is, if the robot chooses the third path 404, the robot has an increased certainty for its location. The increased certainty may enable the robot to improve the avoidance of obstacles 408 in comparison to other paths 400-402.

Additionally, as shown in FIG. 4, one or more radio beacons 410 may be positioned in proximity to the paths 400-404 to gather information from the robot. The information may include, but is not limited to, the speed of the robot, the location of the robot, and/or the distance from the robot to the specific beacon 410. Because the beacons 410 provide information for the robot's location, the robot may have more information about its location when it is near a beacon. Therefore, in most cases, paths that are closer to a beacon have less uncertainty in comparison to paths that are farther from beacons.

As previously discussed, some of the sources of uncertainty in motion planning are a lack of information for the robot's motion model, the robot's sensing model, and/or the environment model. That is, the sources of uncertainty may be motion uncertainty, sensing uncertainty, and map uncertainty. Aspects of the present disclosure refer to motion and sensing uncertainty. Still, aspects of the present disclosure are also applicable to map uncertainty.

In most cases, the Markov decision process (MDP) problem and the partially-observable Markov decision process (POMDP) problem are general solutions for planning problems under motion uncertainty and/or sensing uncertainty.

In a deterministic setting, a path with a minimum cost (e.g., shortest distance) is the desired solution of the motion-planning problem. Still, in a stochastic setting, an improved feedback (mapping) π is the desired solution of the motion-planning problem. In the case of an MDP, π is a mapping from the state space to the control space. Alternatively, in the case of a POMDP, π is a mapping from the belief space to the control space. The mapping π may also refer to a policy.

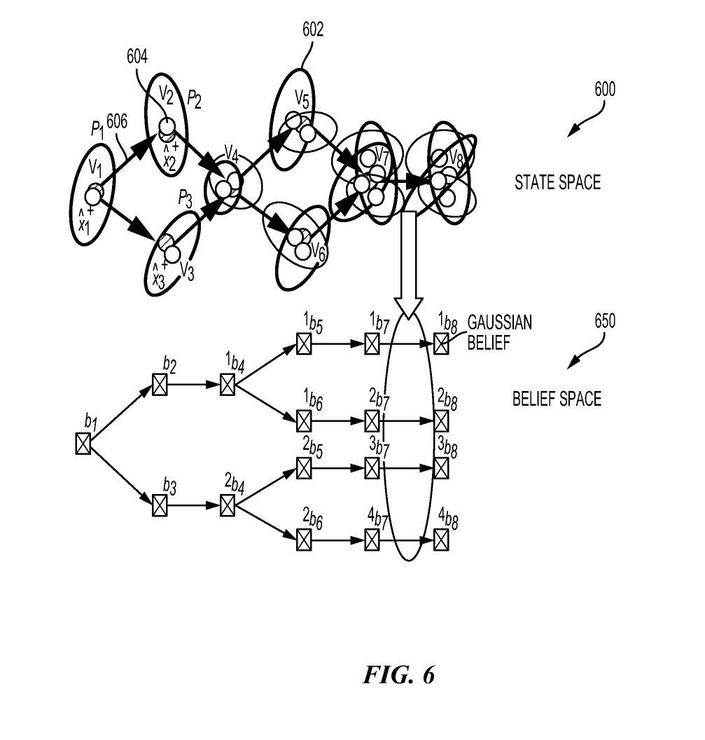

FIG. 5 illustrates an example of a flow diagram for motion planning based on the partially-observable Markov decision process (POMDP). As shown in FIG. 5, a system, such as a robot, has a current system state xₖ, such as a location of the robot, an action uₖ, such as velocity of the wheels, and motion noise wₖ. As shown in FIG. 5, the motion noise wₖ is input to the system. The evolution of the state is based on a function ƒ of the current system state xₖ, action uₖ, and motion noise wₖ. That is, given the current system state, action, and motion noise, the robot will be at a subsequent state xₖ₊₁. In some cases, the action uₖ may be referred to as the control uₖ.

In the present example, a system state x encodes all information specified for decision-making at a specific time instance k. Furthermore, in the present example, the state space is continuous. Additionally, an action space u, which contains all possible control inputs (or actions), can also be continuous, and u_{0:k}:={u₀, u₁, . . . , uₖ} denotes the control history up to step k. Similarly, an observation space z that contains all possible observations (e.g., sensor measurements) can also be continuous, and z_{0:k}:={z₀, z₁, . . . , zₖ} is the observation history up to step k.

As previously discussed, the process model (or the motion model) xₖ+1=ƒ (xₖ, uₖ, wₖ) describes how the system state evolves as a function of the applied action uₖ and the motion (process) noise wₖ, which is distributed according to the (known) probability distribution function (pdf) p(wₖ|xₖ, uₖ).

Although the current system state xₖ may be used to make a decision (e.g., generate an action uₖ), in partially observable systems, the system state (e.g., robot's location) is unknown and the decision-making for a subsequent action may be based on the imperfect measurements made by the sensors. The measurements may also be referred to as observations. As shown in FIG. 5, the measurement zₖ is calculated from h(xₖ, vₖ). Specifically, the measurement zₖ=h(xₖ, vₖ) encodes the relation between the system state xₖ and its measurements zₖ, where vₖ is the observation noise at time step k, which is distributed according to the (known) pdf p(vₖ|xₖ).

Furthermore, as shown in FIG. 5, the measurement zₖ is input to a state estimator, such as a filter, to generate a belief bₖ. That is, in partially observable environments, the available data for decision-making in time k is the history of observations that have made, z_{0:k}, and the history of actions that have been taken, u_{0:k-1}. The data history can be compressed to a conditional probability distribution over all possible states, that is, bₖ=p(xₖ|z_{0:k}; u_{0:k-1}). Specifically, the belief bₖ is the probability of the system state xₖ based on the measurements from time 0 to k and the previous actions that have been taken from time 0 to k−1. That is, the belief is the probability that the robot is in a specific location based on measurements and previous actions.

In recursive state estimation techniques, the belief bₖ may be recursively computed. The belief evolution model (e.g., belief dynamics) introduced by the recursion is based on a function τ. The function τ computes the next belief based on the last action and current observation bₖ₊₁=τ(bₖ, uₖ, zₖ₊₁). Likewise, as shown in FIG. 5, the current belief bₖ may be recursively calculated, such that bₖ=τ(bₖ₋₁, uₖ₋₁, zₖ).

Additionally, as shown in FIG. 5, after determining the belief bₖ, a planner determines a policy π that maps the belief bₖ to the action uₖ. Specifically, as shown in FIG. 5, uₖ=π(bₖ). That is, the policy (e.g., controller) determines which action should be taken based on the current belief of the system.

In most cases, a cost function is specified to determine the policy π. The cost function is a task-dependent quantity. Still, the one-step cost c of taking an action u at belief b may be represented as c(b, u). That is, the cost function determines the cost c of taking action u when at belief b.

Based on the cost function c(b, u), a cost-to-go function ƒ^{π}( ) may be calculated from a belief b₀ under the policy π. The cost-to-go function may specified as J^{π}(b₀)=Σₖ₌₀^{∞}E[c(bₖ, π(bₖ))]. In the cost-to-go function, E[ ] is the expectation operator. The cost-to-go function determines the total expected cost of a policy π. A policy π with a lower cost is more desirable.

Given the motion model ƒ, observation model h, and cost-to-go ƒ^{π}, the POMDP problem seeks the policy with the lowest cost-to-go function from every belief in the belief space. Specifically, the policy with the lowest cost may be determined by the equation π=arg min J^{π}(b₀).

In conventional systems, such as embedded systems, there is an increased time and processing specified for determining a policy. Based on aspects of the present disclosure, the processing time and resources may be decreased by parallelizing the process for determining a policy.

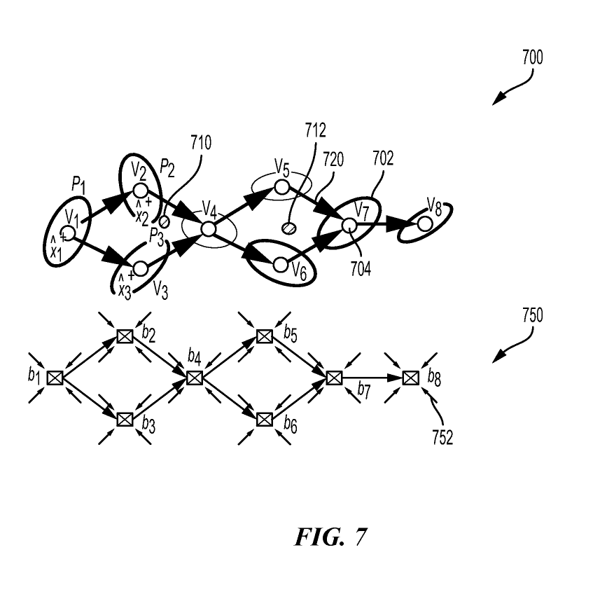

FIG. 6 illustrates a conventional state space and a belief space. The state space is represented as a roadmap 600, such as the probabilistic roadmap method (PRM). Furthermore, the belief space is shown as a tree 650. Each node of the belief space is based on a Gaussian belief, which represents a belief in the system for the location of the robot. Furthermore, each node v₁-v₈ in the state space has a corresponding covariance 602 that represents an amount of information available to the robot at a specific node. Each covariance ellipse is centered at the belief mean 604 corresponding to that node. The mean 604 and covariance 602 corresponding to the Gaussian belief of node i is denoted by bᵢ=(\hat{x}ᵢ⁺, Pᵢ).

For the roadmap 600, the Gaussian distribution evolves over time. That is, the amount of information obtained by the robot varies based on an edge 606 (e.g., path) that is used to travel from one node vₓ to another node v_{y}. For example, when the robot travels from node v₁ to node v₂, the robot's sensors may obtain more information in comparison to the information obtained when the robot travels from node v₁ to node v₃. Therefore, when the robot is at node v₂, it may have more information for its position in comparison to when the robot is at node v₃. As previously discussed, the belief refers to the belief of the robot's current position based on the information available to a robot.

Furthermore, as shown in FIG. 6, both nodes v₂ and v₃ lead to node v₄. Thus, because the robot has different information for its position when it is at node v₂ in comparison to node v₃, when the robot is at node v₄ the robot may have different information (e.g., belief) for its location based on whether the robot traveled to node v₄ via node v₂ or node v₃. Thus, as shown in the roadmap 600, the node v₄ has two different means 604 and two different covariances 602. That is, a first covariance 602 and a first mean 604 are based on reaching node v₄ via node v₂ and a second covariance 602 and a second mean 604 are based on reaching node v₄ via node v₃.

As previously discussed, one of the factors used to determine a cost of a policy is a belief (e.g., probability distribution function). Thus, because each path has a different belief, each path has a different cost. Furthermore, evaluating the costs associated with subsequent paths and/or nodes is dependent on the previous paths that were used to travel to a specific node. For example, the evaluation of node v₈ is dependent on the paths that were used to travel to node v₈.

Additionally, the evaluation of paths may be represented as a tree. FIG. 6 illustrates an example of a tree 650 that is used to evaluate the belief space of a roadmap, such as the roadmap 600 of FIG. 6. As shown in FIG. 6, the tree 650 begins with an initial belief b₁ that corresponds to node v₁ of FIG. 6. Furthermore, the tree branches to two different beliefs, b₂ which corresponds to node v₂, and b₃ which corresponds to node b₃.

Additionally, as shown in FIG. 6, the tree branches from b₂ to 1b₄ and from b₃ to 2b₄. Both 1b₄ and 2b₄ correspond to the different beliefs that may be available at node v₄. As previously discussed, for FIG. 6, the robot may have different information for its location based on whether the robot traveled to node v₄ via node v₂ or node v₃. Thus, 1b₄ and 2b₄ represent the different beliefs that are available at node v₄ based on the different paths available to travel to node v₄.

As shown in FIG. 6, the belief calculated at each node is dependent on the previous path that has been traveled. Thus, to calculate the belief at a final node, such as node v₈, the beliefs of all previous nodes are calculated. Furthermore, the costs and collision probabilities at each node are dependent on the costs and collision probabilities of the previous nodes. Accordingly, there is an increased cost and time for determining the costs and collision probabilities to calculate the belief at a final node. Therefore, it is desirable to independently calculate the costs and collision probabilities of each node. Thus, aspects of the present disclosure are directed to independently calculating the costs and collision probabilities associated with each node.

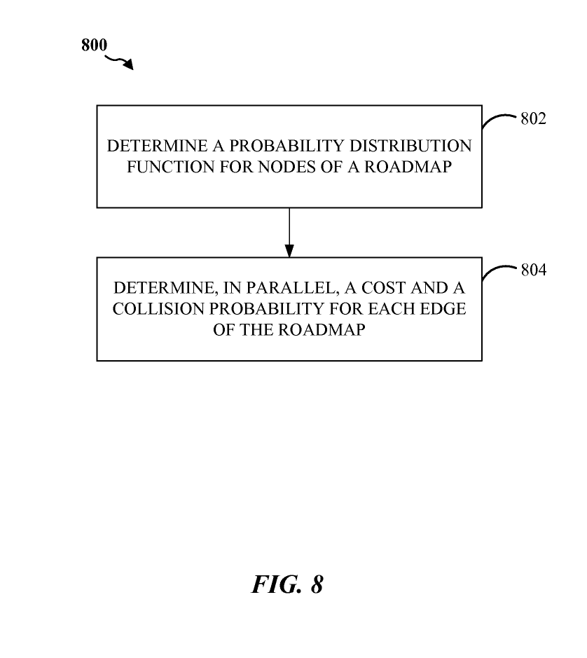

FIG. 7 illustrates an example of a state space and a belief space based on aspects of the present disclosure. The state space is represented as a roadmap 700, such as the belief roadmap method (BRM). Furthermore, the belief space is shown as a tree 750. Each node b₁-b₈ of the belief space is based on a Gaussian belief, which represents a belief in the system for the location of the robot. Furthermore, each node v₁-v₈ on the state space has a covariance 702 that represents an amount of information available to the robot at a specific node v₁-v₈. Furthermore, each covariance 702 has a mean 704 that is the center of the covariance 702. The mean 704 and covariance 702 correspond to the Gaussian belief. That is for a node i, bᵢ=(\hat{x}ᵢ⁺, Pᵢ). The roadmap 700 includes a starting node v₁, an ending node v₈, and intermediary nodes v₂-v₇.

As shown in FIG. 7, a belief stabilizer 752 is applied to each node b₁-b₈ in the belief space. In the present disclosure, the belief stabilizers 752 may be referred to as stabilizers. The stabilizers 752 are used for stabilizing a probability distribution function (e.g., belief) for a robot state in a vicinity of each node to the probability distribution function of the selected node. The robot state may refer to a state, such as, for example, a location of the robot or a zoom level of a robot's camera, etc.

Thus, in contrast to the conventional state space where a node may have more than one mean and/or covariance, based on the one or more stabilizers 752 applied to each node bₓ, each node vₓ in the state space only has one mean 704 and one covariance 702. Accordingly, by stabilizing each node, the cost of each node is independent of the previous paths to reach the node.

In one configuration, a stationary linear quadratic Gaussian (SLQG) controller is used as a belief stabilizer. That is, SLQG controllers are used to stabilize a predefined belief at a node. Of course, aspects of the present disclosure are not limited to stabilizing each node using an SLQG controller and others stabilization techniques are contemplated for stabilizing each node. For example, a node may be stabilized by specifying for the robot to obtain a predetermined amount of information at a particular node. The robot may obtain the predetermined amount of information by maintaining its position at the node for a predetermined time, spinning in a particular direction to collect information with one or more sensors, and/or using multiple combinations of sensors.

In the present configuration, because each node is stabilized to a predefined belief, the evolution beyond a given node is independent of the beliefs of previous nodes. Furthermore, because of the stabilization, the belief space tree collapses to a graph (with cycles). Thus, the belief space tree may grow linearly rather than exponentially. Moreover, based on aspects of the present disclosure, because the belief of each node is stabilized to a predefined belief, the cost of each node/edge may be independently calculated in parallel. For example, a parallel processor may be specified to allocate one thread/computation block to each node/edge so that the cost of each node/edge may be independently calculated in parallel.

Assuming a graph, such as the belief graph or state graph, has n nodes and m edges, and p processors, the nodes and edges may be generated as follows. For parallel node generation, each processor is specified n/p nodes. Furthermore, each processor is specified to generate a random configuration, such as a location, in a robot state space. Furthermore, if the random configuration does not collide with an obstacle, the processor linearizes the motion model and/or the sensor model. Furthermore, after linearizing the system, the processor is specified to solve a Riccati equation corresponding to the linearized system. Additionally, a belief node is computed as a stationary point of the Riccati equation. Finally, the processor saves the belief node.

Furthermore, for parallel edge evaluation, each processor is specified m/p edges. For each edge, the processor is specified to sample the initial node of the i-th edge. Furthermore, for each sample, the processor propagates the samples based on the filter model towards the end node of the edge. Finally, the processor is specified to compute the collision probability and cost along each edge.

The collision probabilities and costs for the edges calculated by each processor along with the belief nodes generated by each processor are transmitted to a central processing unit to determine the dynamic programming for a roadmap. Based on the dynamic programming, a feedback solution (e.g., policy) is generated.

Because the belief nodes and edges are processed in parallel using multiple processors, the speed of generating a feedback solution is linearly increased based on the number of processors.

In one example, as shown in FIG. 7, a robot is specified to move from point A (e.g., node v₁) to point B (e.g., node v₈). Still, there may be obstacles 710, 712 between point A and point B. Therefore, as shown in FIG. 7, a graph is specified to avoid the obstacles via various paths from point A to point B. The graph edges 720 may be generated in serial or in parallel. After generating the graph (e.g., roadmap), a probability distribution function is generated for each node along the graph. The probability distribution function is used to generate a belief for each node.

To determine a policy with the lowest cost, the system may calculate a cost and a collision probability for each edge. For example, the collision probability determines the probability of colliding with an obstacle when moving from one node, such as node v₁, to a second node, such as node v₂. Furthermore, the cost determines the costs, such as spent fuel and/or accumulated uncertainty, when moving from one node, such as node v₁, to a second node, such as node v₂.

Still, the robot does not know where it will begin within the border of the probability distribution function (e.g., ellipse of FIG. 7) for each node. There is an increased probability that the robot will start in the center of the probability distribution function. Nonetheless, there is also a probability that the robot may begin at any point within the probability distribution function. Therefore, the system is specified to sample multiple points x within the probability distribution function. The multiple points represent possible starting points for the robot.

Furthermore, for each sample, the system determines a collision probability for moving from the node, such as v₁, to another node, such as v₂. That is, for each edge, the system determines a cost and collision probability by determining cost values and collision events for each of the multiple samples associated with each edge. The determination is based on a simulation of the environment. Based on the determination, the system may determine that a specific number of samples y did not cause a collision. Thus, the success probability is determined based on the ratio of the number of samples that did not collide y and the original number of samples x. The system may also determine a cost associated with each sample. Furthermore, the system may determine an average cost for an edge based on the cost of each sample.

The cost and collision probability are determined for the multiple samples for each node. As previously discussed, in conventional systems, the nodes/edges were dependent on each other. Therefore, in conventional systems, the costs and transition probabilities of the edges are serially calculated. Based on aspects of the present disclosure, the nodes/edges are independent. Therefore, the cost and collision probability for the multiple samples of each edge may be calculated in parallel by multiple processors (e.g., parallel processing) to increase the speed of determining a policy.

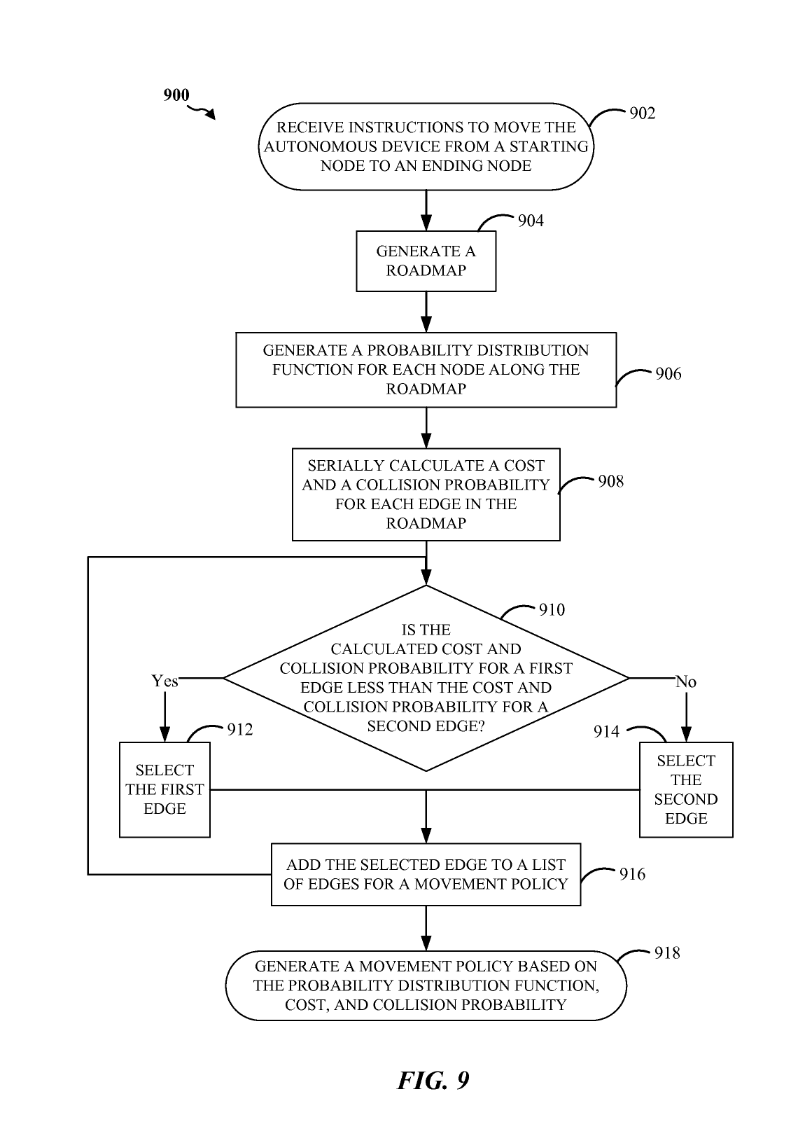

FIG. 8 illustrates a method 800 for determining a movement policy. In one configuration, the movement policy is a closed loop policy that determines movement to the end node from any of the other nodes. In block 802, multiple processors are specified to determine a probability distribution function for multiple nodes of a roadmap. Furthermore, in block 804, the multiple processors are specified to determine, in parallel, a cost and collision probability for each edge of the roadmap.

FIG. 9 illustrates a method 900 for determining a movement policy. At block 902, a system associated with an autonomous device, such as a robot, receives instructions to move the autonomous device from a starting node to an ending node. Additionally, at block 904, a roadmap is generated. The roadmap includes a start node, an end node, and two or more intermediary nodes. After generating the roadmap, a probability distribution function is generated for each node along the graph (block 906).

Moreover, at block 908, the system serially calculates a cost and a collision probability for each edge. At block 910, the system determines if the calculated cost and collision probability for a first edge connecting a first node to a second node is less than the cost and collision probability for a second edge connecting a first node to a second node. If the cost and collision probability for the first edge is less than the cost and collision probability for the second edge, the system selects the first edge (block 912). Alternatively, if the cost and collision probability for the first edge is greater than the cost and collision probability for the second edge, the system selects the second edge (block 914).

Based on the selected edge, at block 916, the system adds the selected edge to a list of edges for a movement policy. The system continues the process until all of the edges are selected. After all of the edges are selected, the system generates a movement policy based on the probability distribution function, cost, and collision probability (block 918).

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for generating a movement policy, comprising:
determining a probability distribution function (PDF) for a plurality of nodes of a roadmap, the plurality of nodes including at least a start node, an end node, and at least two intermediary nodes;
determining, in parallel, a cost and a collision probability for each edge of the roadmap, and each edge connecting two of the plurality of nodes; and
generating the movement policy based at least in part on the PDF, the cost, and the collision probability.

2. The method of claim 1, in which the movement policy is a closed loop policy that determines movement to the end node from any of the plurality of nodes.

3. The method of claim 1, further comprising determining the cost and the collision probability for each edge by calculating cost values and collision events for each of a plurality of samples associated with each edge.

4. The method of claim 1, further comprising stabilizing a probability distribution function for a robot state in a vicinity of each selected node to the PDF of the selected node.

5. The method of claim 1, in which a first cost and a first collision probability of a first edge of a plurality of edges is independent of a second cost and a second collision probability of a second edge of the plurality of edges.

6. An apparatus for generating a movement policy, comprising:
a memory unit; and
at least one processor coupled to the memory unit, the at least one processor configured:
to determine a probability distribution function (PDF) for a plurality of nodes of a roadmap, the plurality of nodes including at least a start node, an end node, and at least two intermediary nodes;
to determine, in parallel, a cost and a collision probability for each edge of the roadmap, and each edge connecting two of the plurality of nodes; and
to generate the movement policy based at least in part on the PDF, the cost, and the collision probability.

7. The apparatus of claim 6, in which the movement policy is a closed loop policy that determines movement to the end node from any of the plurality of nodes.

8. The apparatus of claim 6, in which the at least one processor is further configured to determine the cost and the collision probability for each edge by calculating cost values and collision events for each of a plurality of samples associated with each edge.

9. The apparatus of claim 6, in which the at least one processor is further configured to stabilize a probability distribution function for a robot state in a vicinity of each selected node to the PDF of the selected node.

10. The apparatus of claim 6, in which a first cost and a first collision probability of a first edge of a plurality of edges is independent of a second cost and a second collision probability of a second edge of the plurality of edges.

11. An apparatus for generating a movement policy, comprising:
means for determining a probability distribution function (PDF) for a plurality of nodes of a roadmap, the plurality of nodes including at least a start node, an end node, and at least two intermediary nodes;
means for determining, in parallel, a cost and a collision probability for each edge of the roadmap, and each edge connecting two of the plurality of nodes; and
means for generating the movement policy based at least in part on the PDF, the cost, and the collision probability.

12. The apparatus of claim 11, in which the movement policy is a closed loop policy that determines movement to the end node from any of the plurality of nodes.

13. The apparatus of claim 11, further comprising means for determining the cost and the collision probability for each edge by calculating cost values and collision events for each of a plurality of samples associated with each edge.

14. The apparatus of claim 11, further comprising means for stabilizing a probability distribution function for a robot state in a vicinity of each selected node to the PDF of the selected node.

15. The apparatus of claim 11, in which a first cost and a first collision probability of a first edge of a plurality of edges is independent of a second cost and a second collision probability of a second edge of the plurality of edges.

16. A non-transitory computer-readable medium having program code recorded thereon, the program code being executed by a processor and comprising:
program code to determine a probability distribution function (PDF) for a plurality of nodes of a roadmap, the plurality of nodes including at least a start node, an end node, and at least two intermediary nodes;
program code to determine, in parallel, a cost and a collision probability for each edge of the roadmap, and each edge connecting two of the plurality of nodes; and
program code to generate a movement policy based at least in part on the PDF, the cost, and the collision probability.

17. The non-transitory computer-readable medium of claim 16, in which the movement policy is a closed loop policy that determines movement to the end node from any of the plurality of nodes.

18. The non-transitory computer-readable medium of claim 16, in which the program code further comprises program code to determine the cost and the collision probability for each edge by calculating cost values and collision events for each of a plurality of samples associated with each edge.

19. The non-transitory computer-readable medium of claim 16, in which the program code further comprises program code to stabilize a probability distribution function for a robot state in a vicinity of each selected node to the PDF of the selected node.

20. The non-transitory computer-readable medium of claim 16, in which a first cost and a first collision probability of a first edge of a plurality of edges is independent of a second cost and a second collision probability of a second edge of the plurality of edges.
